(19) United States
(12) Patent Application Publication
(10) Pub. No.: US 2007/0264100 A1
(43) Pub. Date: Nov. 15, 2007

(54) Multi-Pitch Screw and Method and Apparatus for manufacturing Multi-Pitch Screw

(75) Inventors: Hiroshi Fujii, Aichi (JP); Naoki Sase, Toyama (JP); Kenichi Katayama, Gifu (JP); Yoshinori Moriguchi, Gifu (JP)

Correspondence Address: LUCAS & MERCANTI, LLP, 475 PARK AVENUE SOUTH, 15TH FLOOR, NEW YORK, NY, 10016, US

(73) Assignee: NAGOYA INDUSTRIAL SCIENCE RESEARCH INSTITUTE, AICHI (JP)

(21) Appl. No.: 11/719,008

(22) PCT Filed: Nov. 7, 2004
(86) PCT No.: PCT/JP05/20355

§ 371 Date: May 10, 2007

(30) Foreign Application Priority Data
Nov. 19, 2004 (JP) 2004335315

(51) Int. Cl. B23P 17/00; F16B 35/00

(52) U.S. Cl. 411/411; 29/284; 29/592

(57) ABSTRACT

To present a method of manufacturing a multipitch screw easily by using flat dies suited to mass production. A flat die 4 includes linear ordinary screw threads 40a, and multipitch screw threads 40b consecutive to the ordinary screw threads 40a, slightly shorter in height than the ordinary screw threads 40a, with both side walls formed alternately and consecutively, alternating between a section departing from the central line 40c of screw threads and an approaching section along a central line 40c, and symmetrically to the central line 40c of screw threads. After forming the tacks of a constant lead angle screw on the outer circumference of a shaft-like blank piece by the ordinary screw threads 40a, tracks of a multipitch screw are formed by the multipitch screw threads 40b, and therefore the tracks of a multipitch screw varying in the force applied at the time of rolling can be formed easily.

### TECHNICAL FIELD

The invention relates to a multipitch screw having a plurality of leads (multipitch screw having screw threads formed alternately and consecutively by alternating between a lead angle obtuse section and a lead angle acute section while rotating one revolution along a helix), and a manufacturing method and a manufacturing apparatus of the same.

### BACKGROUND ART

Numerous countermeasures have been proposed against loosening of tightening screws, but nothing has been sufficiently.

The inventors have confirmed that the problem can be solved by a “multipitch screw” having a plurality of leads, that is, consecutive leads varied in pitch, which has drastically changed the conventional concept of a screw “having a spiral of a fixed pitch” (non-patent document 1).

The inventors have also proposed the structure and combinations of bolts and nuts of a multipitch screw having a plurality of leads, and their application in a feed screw mechanism in JP 2002-346891.

Similarly, the inventors have already proposed the multipitch screw manufactured by using a rotary die, its manufacturing method and manufacturing apparatus, and further nut members having the multipitch screw in JP 2004-230119 and JP 2004-230120.

Similar known technologies include an anti-loosening bolt having double threads in the shaft portion of a same bolt, and a pair of flat dies for manufacturing the same (see, for example, “Manufacturing method of anti-loosening bolt” disclosed in prior art 1).

Other proposals for preventing from loosening include male threads having a plurality of convexes provided consecutively at specific intervals in the thread flank surface, a flat die for rolling the same, and a method for manufacturing the same (see, for example, “Rolling flat die, and manufacturing method of the rolling flat die” disclosed in prior art 2).

[PriorArt 1] JP 2003-305528A is incorporated herein by reference.

[PriorArt 2] JP 2004-130356A is incorporated herein by reference.

[Non-patent document 1] Collected papers of Japan Society of Mechanical Engineers, Part C, Vol. 62 (No. 597), pp. 1963-1968m “Development of extremely less likely-to-be-loosen screw tightening structures,” FUJII, Hiroshi, et al., 1996)

### DISCLOSURE OF THE INVENTION

### Problems to be Solved by the Invention

To prevent loosening of a tightening screw, the multipitch screw (a bolt member) is extremely effective, but it is extremely difficult to process the shape of the multipitch screw at high precision, and technology for manufacturing at low cost is not established yet, and it is far from being practical. Similarly, as for the feed screw mechanism based on the principle of this multipitch screw, manufacture of the feed screw (bolt member) is difficult and expensive.

In the multipitch screw that can be manufactured by using the rotary die proposed by the inventor, and its manufacturing method and manufacturing apparatus, it is a basic condition to make uniform the blank materials at the time of rolling by using a plurality of rotary dies, and to keep a pitch balance of threads to be processed. In other words, since the rotary die is used, it is difficult to apply to the manufacturing method by the flat die suited to mass production.

The anti-loosening bolt of prior art 1 belongs to the double threads and double nuts of the prior art, and is essentially different from the multipitch screw. Hence, this manufacturing method cannot be directly applied to manufacture of a multipitch screw.

Male threads of prior art 2 are based on a simple structure having a plurality of convexes provided on the flank surface of a screw, and the plurality of convexes are mere small bumps only tall enough to increase the coefficient of friction between the nut side and the flank surface when tightening.

Accordingly, it is enough to form only a plurality of small recesses at specific intervals on the flank surface of the flat die side, and manufacture of die is simple, and the shape of male threads is basically the same as in the existing screw, and the rolling process is easy.

On the other hand, the multipitch screw requires screw threads varying regularly and uniformly on a plurality of flank surfaces which form a plurality of lead surfaces, and the manufacturing method of prior art 2 cannot be applied directly.

In other words, the multipitch screw is formed in a structure in which a plurality of flank surfaces forming a plurality of lead surfaces are present, and flank surfaces varying regularly at the time of rolling must be formed, and screw threads cannot be rolled and formed at high precision by the conventional flat die.

It is hence an object of the invention to present a multipitch screw (bolt member) having optimal screw threads easily rolled and processed by a flat die suited to mass production, and a method of manufacturing the same, and its manufacturing apparatus.

### Means for Solving the Problems

To achieve the object described above, the invention as set forth in claim 1 is technically characterized by a multipitch screw having left and right side walls 201L, 201R and 202L, 202R of screw threads 20, formed alternately and consecutively, alternating between a lead angle obtuse section 201 and a lead angle acute section 202 while rotating one revolution along a helix, and symmetrically to a central line 20c of screw threads 20.

The invention as set forth in claim 3 is technically characterized by a manufacturing method of a multipitch screw comprising the steps of rolling and processing spiral multipitch screw threads 20 on an outer circumference 2 of a shaft-like blank piece 1, by a pair of flat dies 4, 5 having a plurality of substantially inverted-V protrusions 40b, 50a on the surface,

wherein at least one flat die 4 has protrusions 40b for screw threads of the lead angles regularly varying alternately and consecutively having both side walls alternating between a section 401 departing from the central line 40c and an approaching section 402 along the central line 40c, and symmetrically to the central line, and

multipitch screw threads 20 are rolled on the outer circumference 2 of the shaft-like blank piece 1, alternately and consecutively, alternating between lead angle obtuse sections 201L, 201R and acute sections 202L, 202R, by protrusions 40b for screw threads regularly varying in the lead angle of one flat die 4.

The invention as set forth in claim 4 is technically characterized by a manufacturing method of a multipitch screw comprising the steps of rolling and processing spiral multipitch screw threads 20 on an outer circumference 2 of a shaft-like blank piece 1, by a pair of flat dies 4, 5 having a plurality of substantially inverted-V protrusions 40a, 40b, and 50a on the surface,

wherein at least one flat die 4 has a region 410 for screw threads 40a of a constant lead angle in protrusions, and a region 420 for screw threads 40b of a lead angle varying regularly to be symmetrical to a central line 40C, consecutive to the region 410, slightly lower in height than this region for screw threads of the constant lead angle, and alternately and consecutively, alternating in both side walls between a section 401 departing from the central line 40c of protrusions 40b and an approaching section 402 along the central line 40c, and

multipitch screw threads are rolled on the outer circumference 20 of the shaft-like blank piece 1, overlaid between tracks 210 of constant lead angle screw threads formed by the protrusions 40a of the region 410 for constant lead angle screw threads of one flat die 4, and screw tracks alternately and consecutively, alternating between the lead angle obtuse section 201 and the acute section 202 formed by protrusions 40b of the region 420 for a screw thread of a lead angle varying regularly.

The invention as set forth in claim 5 is technically characterized by a manufacturing method of a multipitch screw comprising the steps of rolling and processing spiral multipitch screw threads 20 on an outer circumference 20 of a shaft-like blank piece 1, by a pair of flat dies 4, 5 having a plurality of substantially inverted-V protrusions 40a, 40b′, and 50a on the surface,

wherein at least one flat die 4 has a region 410 for screw threads of a constant lead angle in protrusions 40a, and a region 420 for screw threads 40b of a lead angle varying regularly in stair steps, consecutive to the region 410, slightly wider in width of a sectional shape than this region for screw threads of the constant lead angle, slightly lower in height, and varying like waves in a groove direction, and

multipitch screw threads 20 are rolled on the outer circumference 20 of the shaft-like blank piece 1, overlaid between tracks 21b of a constant lead angle screw threads formed by the protrusions 40a of the region 210 for constant lead angle screw threads of one flat die 4, and screw tracks 201, 202 in stair steps, formed by protrusions 40b′ of the region 420 for screw threads of a lead angle varying regularly.

### EFFECTS OF THE INVENTION

According to claim 1 of the invention, side walls 201, 202 of screw threads 20 are alternate and consecutively, alternating between a lead angle obtuse section 201 and a lead angle acute section 202 while rotating along a helix. By forming such multipitch screw, the effective lead of the entire screw becomes an average value of a lead angle obtuse section and a lead angle acute section. The resisting force to loosening of the screw is dominant in the frictional force to the opposite member in the lead angle obtuse section by axial force, and hence a stronger anti-loosening action is realized by the frictional force in the lead angle obtuse section, while maintaining a large effective lead. Side walls 201, 202 of screw threads are formed to be symmetrical to the central line 20c of screw threads. That is, the screw threads and screw grooves are always left and right symmetrical, and the workpiece (bolt 1) can be rolled and processed without generating excessive force to vary its axial center.

According to claim 2 of the invention, since the lowest position of the screw groove (bottom between screw thread 20 and screw thread 20) 21b has a constant lead angle in a general spiral screw shape, and the leading end portion of the opposite side screw slides in the lowest position 21b, and smooth screw feeding and tightening can be realized. Besides, since the lowest position 21b is always provided in the bottom of the screw groove 210, stability of rolling and processing of a workpiece (bolt 1) is further enhanced.

According to claim 3 of the invention, both side walls 401, 402 formed alternately and consecutively, alternating between a section 401 departing from a central line 40c of protrusions 440b and an approaching section 402 along the central line 40c, and symmetrically to the central line 440c of protrusions 40b, and by such protrusions 40b for screw threads varying regularly in lead angle, a multipitch screw 20 is rolled around the outer circumference 2 of the shaft-like blank piece 1. In other words, the screw threads and screw grooves are always symmetrical left and right, and rolling and processing can be executed stably without generating excessive force to vary the axial center of the shaft-like blank piece 1.

According to claim 4 of the invention, protrusions of a flat die 4 include a region 410 for screw threads 40a of a constant lead angle provided linearly, and a region 420 for screw threads 40b of a lead angle varying regularly, provided consecutively to the region 410, and slightly lower in height than the region 410, with both side walls 401, 402 formed alternately and consecutively, alternating a section 401 departing from the central line of protrusions 40b and an approaching section 402, and symmetrically to the center line 40c of protrusions 40b. First by protrusions 40a of the region 410 for screw threads of a constant lead angle, tracks 210 of a constant lead angle screw are formed on the outer circumference 2 of the shaft-like blank piece 1, and successively by protrusions 40b of the region 420 for screw threads of a lead angle varying regularly, tracks of the multipitch screw 20 consecutive between a section 201 of lead angle obtuse and a section 202 of lead angle acute are formed, therefore tracks of a multipitch screw changing in force applied at the time of rolling can be formed easily.

According to claim 5 of the invention, protrusions 40a, 40b of a flat die 4 include a region 410 for screw threads of a constant lead angle provided linearly, and a region 420 for screw threads of a lead angle varying regularly, provided consecutively to the region 410, and slightly broader in width of the sectional shape than the region 410 and lower in height and provided in stair steps changing like waves in the groove direction. First by protrusions 40a of the region 410 for screw threads of a constant lead angle, tracks 21b of a constant lead angle screw are formed on the outer circumference 2 of the shaft-like blank piece 1, and successively by protrusions 40b of the region 420 for screw threads of a lead angle varying regularly, tracks 201, 202 of a stair step screw are formed, therefore tracks of a multipitch screw changing in force applied at the time of rolling can be formed easily.

According to claim 6 of the invention, the pair of flat dies 4, 5 consist of a flat die 4 having protrusions 40a, 40b formed of the region 410 for screw threads of a constant lead angle and the region 420 for screw threads of a lead angle varying regularly, and a flat die 5 having only protrusions 50a for screw threads of constant lead angle.

Theoretically, both flat dies may be realized by flat dies for manufacturing screw threads of a lead angle varying regularly, but if processed very precisely, a processing error occurs from both flat dies for manufacturing screw threads of a lead angle varying regularly, the multipitch screw threads rolled in the region for screw threads of a lead angle varying regularly by the protrusions of one flat die for manufacturing screw threads of a lead angle varying regularly are flattened in the region for screw threads of lead angle varying regularly by the protrusions of other flat die for manufacturing screw threads of a lead angle varying regularly, and it is very difficult to be realized. By contrast, in claim 6 of the invention, since the screw threads are not flattened by the protrusions of flat dies for manufacturing screw threads of a lead angle varying regularly, flat dies for manufacturing screw threads of a lead angle varying regularly of very high processing precision are not required, and by one flat die for manufacturing screw threads of a lead angle varying regularly, a multipitch screw can be manufactured appropriately. Further, it is very hard and expensive to manufacture flat dies for manufacturing screw threads of a lead angle varying regularly, but only one of such die is required in the pair of flat dies in claim 6, and multipitch screws can be manufactured at low cost.

### BEST MODE FOR CARRYING OUT THE INVENTION

### First Embodiment

Referring first to FIG. 1 to FIG. 4, the multipitch screw of first embodiment of the invention using screw threads of nearly triangular section is explained. In FIG. 1, a tightening bolt 1 has multipitch threads 2. Screw threads 20 of multipitch threads 2 are magnified in FIG. 2. A linearly developed shape is shown in FIG. 3. The screw thread 20 includes a crest 203 and two left and right flank surfaces 201L, 201R, 202L, 202R provided at both sides differing in pitch. A bottom 21 is formed between thread 20 and thread 20. The left and right flank surfaces 201L, 201R, 202L, 202R are formed alternately and consecutively, alternating between a section (left and right flank surfaces 201L, 201R) departing from the central line 20c of the thread 20 and an approaching section (flank surfaces 202L, 202R) along the central line 20c, and these two left and right flank surfaces 201L, 201R, 202L, 202R are symmetrical to the central line 20c. As shown in FIG. 2, along the helis line (track of central line), the right flank surface 201R forms a lead angle obtuse section, and the left flank surface 201L forms a lead angle acute section. The flank surfaces 202L, 202R consecutive to the left and right flank surfaces 201L, 201R form a lead angle acute section at the right side 202R and a lead angle obtuse section at the left side 202L.

FIG. 4 is a sectional view of the thread 20 along sections Xa to Xd in FIG. 3, and FIG. 4 (A) corresponds to section Xa-Xa in FIG. 3, FIG. 4 (B) to section Xb-Xb in FIG. 3, FIG. 4 (C) to section Xc-Xc in FIG. 3, and FIG. 4 (D) to section Xd-Xd in FIG. 3. The thread 20 is more specifically described below with reference to these drawings. The crest 203 of the thread 20 is a substantially elongated rhombic by each side of four left and right flank surfaces 201L, 201R, 202L, 202R. In the linearly developed view in FIG. 3, the crest 203 is shown in a rhombic shape, but the actual shape is enclosed by curves on all sides as shown in the magnified view in FIG. 2.

Two left and right flank surfaces 201L, 201R, 202L, 202R are set in the same length in the leading direction of the thread 20, and are joined at junctions 2A, 2B. The central line 20c of the thread 20 is set to be located always in the center of the confronting left and right flank surfaces 201L, 201R, 202L, 202R, and is positioned on the track of the average pitch of two pitches determined by the left and right flank surfaces 201L, 201R, 202L, 202R.

The bottom 21 formed between thread 20 and thread 20 is changed in the section along with the leading action of the thread 20 as shown in FIGS. 4 (A), (B), (C), and (D).

In other words, at the junction 2A of the thread 20, the bottom 21 has a simple V shape as shown in FIG. 4 (A), and width and shape of the bottom are changed gradually at positions shown in FIGS. 4 (B), (C), and (D). At the positions in FIGS. 4 (B), (C), and (D), the lowest position 21b of the bottom 21 is always at a specific position, and along with the leading action of the thread 20, left and right symmetrical steps 21a, 21a slightly shallower than the lowest position 21b are formed at both sides of the lowest position 21b, and the width W of the steps 21a is regularly increased and decreased. Specifically, at the junction 2A shown in FIG. 4 (A), there is no step 21a, and the width W of the step 21a at the junction 2A is increased as going toward the junction 2B in FIG. 4 (C), reaching the maximum at the junction 2B, and the width W of the step 21a is narrowed gradually as going toward the next junction 2A as shown in FIG. 4 (D).

Therefore as the thread 20 advances, the substantially V-shaped screw groove 210 shown in FIG. 4 (A) is formed continuously in parallel virtually to the central line 20c of the thread 20. Hence, both sides of the substantially V-shaped screw groove 210 virtually formed continuously are changed along the left and right flank surfaces 201L, 201R, 202L, 202R regularly while keeping constant the lowest position 21b.

Next, with reference to FIG. 5 to FIG. 7, a method of manufacturing the multipitch screw of first embodiment having screw threads of substantially triangular section is explained.

FIG. 5 is an explanatory diagram of principle of manufacture by rolling the threads 2 of the bolt 1 by using a pair of flat dies 4, 5. FIG. 6 (A) is a perspective view of the flat die 4 for manufacturing multipitch screw, and FIG. 6 (B) is a perspective view of flat die 5 for manufacturing constant pitch screw. The flat die 4 is a substantially rectangular thick plate, screw threads 40 of nearly opposite shape of the screw threads 20 shown in FIG. 3 and FIG. 4 are formed on the opposite processing side 4a substantially linearly at a specific inclination to the side of a rectangle. The flat die 4 is for forming a multipitch screw, and the flat die 5 is for forming a conventional constant pitch screw.

At the front and rear ends of the flat die 4 and the flat die 5, known slants 400, 400, 500, 500 (biting parts, relief parts) are formed for enhancing the stability and efficiency of rolling process.

As shown in FIG. 6 (A), the screw thread 40 of the flat die 4 for multipitch screw is divided into a first range 410, a second range 420, and a third range 430 from the front side of the moving direction (the relatively moving direction of a pair of flat dies, or direction of arrow A in FIG. 5 and FIG. 6). The first range 410 occupies about half of the length direction of the flat die 4, and the second range 420 and the third range 430 occupy about one fourth each in the length direction of the flat die 4, and the third range 430 is set to be equivalent to the circumference of the bolt 1 to be rolled and processed.

In the first range 410 and the third range 430 of the flat die 4, linear ordinary screw threads 40a are formed continuously as shown in partially magnified view in FIG. 7 (A) or sectional view in FIG. 7 (B), nearly same as the substantially V-shaped screw grooves 210 virtually shown in FIG. 4 (A). In the second range 420, multipitch screw threads 40b are formed continuously in a shape substantially corresponding to the screw grooves 210 shown in FIGS. 4 (A), (B), (C), and (D), excepting the lowest position 21b. FIG. 7 (C) is a partially magnified view of multipitch screw thread 40b, and FIG. 7 (D) is a sectional view, and for the ease of understanding, the screw thread 40a is virtually overlaid. The multipitch screw threads 40b are slightly lower than the ordinary screw threads 40a. Side walls 401L, 401R of the multipitch screw thread 40b are spaced along the central line 40c, and side walls 402L, 402R approach along the central line. The side walls 401 and side walls 402 are alternately consecutive, alternating along the central line 40c. The both side walls 401L, 401R and side walls 402L, 402R are formed symmetrically to the central line 40c of the multipitch screw thread 40b.

On the other hand, linear ordinary screw threads 50a are consecutively formed, nearly same as the substantially V-shaped screw grooves 210 virtually shown in FIG. 4 (A) in the entire flat die 5 for constant pitch shown in FIG. 6 (B). The ordinary screw threads 50a are same in shape as the ordinary screw threads 40a shown in FIG. 7 (A) and FIG. 7 (B).

A method of rolling the multipitch screw threads 2 in the bolt 1 by using the pair of dies 4, 5 is explained with reference to FIG. 5. The pair of flat dies 4, 5 are installed in a known rolling machine. The both flat dies 4, 5 have their processing sides 4a, 5a disposed to be opposite to each other at a specific interval according to the size of the bolt 1 to be rolled, and are moved in the direction indicated by arrows A and B.

When the shaft of the bolt 1 is inserted in the slants 400 of the pair of dies 4, 5, and the flat dies 4, 5 are moved in the opposite directions indicated by arrows A and B in this state, and the shaft of the bolt 1 rotates relatively, and rotates and moves along the first range 410, the second range 420, and the third range 430 of the flat die 4. First, in the shaft of the bolt 1, substantially V-shaped screw grooves 210 shown virtually in FIG. 4 (A) are formed in the first range 410 of the flat die 4, and in the ordinary screw threads 50a of the flat die 5. In the second range 420 of the flat die 4, screw grooves are formed in a shape substantially conforming to the screw grooves 210 shown in FIGS. 4 (A), (B), (C), and (D), excepting the lowest position 21b. The third range 430 of the flat die 4 and ordinary screw threads 50a of the flat die 5 work to shape the bolt 1 and send it out in a profile copying the V-shaped screw grooves 210 formed in the first range 410.

In other words, by the first range 410, the second range 420 and the third range 430 of the flat die 4 and the ordinary screw threads 50a of the flat die 5, screw grooves 210 shown in FIGS. 4 (A), (B), (C), and (D) are formed in the shaft of the bolt 1, and thereby comparative multipitch screw threads 20 are formed.

The substantially V-shaped screw grooves 210 formed by the first range 410 of the flat die 4 and the ordinary screw threads 50a of the flat die 5 are, as shown in FIG. 8, left and right symmetrical to the central line L of the screw grooves, the same as in the conventional ordinary screw, and the reaction forces F1, F2 at the time of rolling process are symmetrical to the vertical plane passing the central line L. Hence, the bolt 1 can be rolled and processed stably without generating excessive force to vary the axial center.

Also as shown in FIG. 9, the V-shaped screw grooves 210 formed by the second range 420 of the flat die 4 have the right and left side walls varying regularly, but are always symmetrical right and left to the central line L of the screw grooves. Accordingly, reaction forces Fa, Fb at the time of rolling process increase and decrease regularly, but their magnitudes are always symmetrical to the vertical plane passing the central line L. Hence, also when processing the second range 420 of the flat dies 4, 5, the bolt 1 can be rolled and processed stably without generating excessive force to vary the axial center.

### Modified Example of First Embodiment

The first embodiment shown in FIG. 1 to FIG. 4 relates to the multipitch screw of substantially triangular screw threads suitable to a tightening screw, that is, the screw threads of substantially triangular in which, once tightened with a nut, the nut is hardly removed. By contrast, a modified example of first embodiment shown in FIG. 10 and FIG. 11 relates to a multipitch screw of a substantially trapezoidal screw threads preferably used in feed screw or bolt screw in which moves nuts such as a feed screw frequently. In the feed screw, the substantially trapezoidal screw threads are beneficial for enhancing the efficiency and mechanical strength.

FIG. 10 is a linearly developed diagram of a multipitch screw in the modified example of first embodiment using the trapezoidal screw threads. FIG. 11 is a sectional view of the thread 30 along sections Xa to Xd in FIG. 10, and FIG. 11 (A) corresponds to section Xa-Xa in FIG. 10, FIG. 11 (B) to section Xb-Xb in FIG. 10, FIG. 11 (C) to section Xc-Xc in FIG. 10, and FIG. 11 (D) to section Xd-Xd in FIG. 10. The substantially trapezoidal thread 30 has its both sides formed of two left and right flank surfaces 301L, 301R, 302L, 302R each different in pitch, and its crest 303 is formed in an elongated rhombic shape same as in the triangular thread. A bottom 31 formed between thread 30 and thread 30 is changed in the section along with advance of the screw threads 30. In the bottom 31, as shown in FIG. 11 (A), screw grooves 310 of a substantially simple inverted trapezoidal shape are continuously formed virtually, and symmetrical steps 31a, 31a slightly shallower than the lowest 31b are formed at both sides of the lowest position 31b. The width of the steps 31a increases and decreases regularly and repeatedly along with advance of the thread 30. The multipitch screw in the modified example of first embodiment can also be rolled by using the flat dies same as in the first embodiment explained in FIG. 5 to FIG. 9.

### Second Embodiment

With reference to FIG. 12 to FIG. 16, the manufacturing method and a manufacturing apparatus of a multipitch screw in second embodiment of the invention are explained.

In the first embodiment explained in FIG. 3, side walls of screw threads are formed alternately and consecutively, alternating between lead angle obtuse section and lead angle acute section while rotating along the helix line, and symmetrically to the central line of screw threads. In the second embodiment, on the contrary, screw threads are formed in stair steps changing like waves in the groove direction as shown in FIG. 12 and FIG. 13.

In FIG. 12, a tightening bolt 1 has multipitch threads 2. Screw threads 20 of multipitch threads 2 are linearly developed and shown in FIG. 13. FIG. 13 (A) and FIG. 13 (B1) are views of a same cut end, but are different in a sectional position and a viewing angle. On the other hand, FIG. 13 (B1) and FIG. 13 (B2) are same views, but the moving area by plastic processing is indicated by cross hatching in FIG. 13 (B2). In other words, the cross hatching area in FIG. 13 (B2) is processed plastically, and formed into a shape shown in FIG. 13 (B1). The lowest position 21b is a general (constant lead angle) spiral screw track formed by threads 40a for manufacturing a constant lead angle screw of the flat die same as in the first embodiment. The left and right flank surfaces 201L, 201R, 202L, 202R are stair step screw tracks. In the second embodiment, the both lowest positions 21b and stair step left and right flank surfaces 201L, 201R, 202L, 202R are overlaid to form multipitch screw threads 20, which are formed on the outer circumference of the multipitch screw portion 2.

As shown in the principle diagrams in FIG. 13 (A) and FIG. 13 (B1), the majority of both sides (left and right flank surfaces 201L, 201R, 202L, 202R excluding the vicinity of lowest position 21b) of the substantially V-shaped screw threads 20 forms a stair step or a multipitch screw (alternate and consecutive, alternating between a lead angle obtuse section and a lead angle acute section while rotating one revolution along the helix line). The lowest position (the bottom between thread and thread) 21b of the screw threads 20 is in a general spiral screw shape and a constant lead angle.

By forming the multipitch screw in this manner, the effective lead of the entire screw is the average between a lead angle obtuse section and a lead angle acute section. The resisting force to loosening of screw is dominant in the frictional force to the opposite member in the lead angle obtuse section by an axial force, and hence a stronger anti-loosening action is realized by the frictional force in the lead angle obtuse section, while maintaining a large effective lead. On the other hand, since the lowest position (the bottom between thread and thread) 21b of the screw threads 20 is in a general spiral screw shape with a constant lead angle, the leading end of the opposite screw slides in the lowest position, and smooth screw feed and screw tightening can be realized.

The lead angle in the lead angle obtuse section can be set to zero (flat).

As a result, in the lead angle zero section, the axial force is directly changed into the frictional force, and a component force to turn the screw does not work at all, and the frictional force is reinforced in the lead angle zero section, and a stronger anti-loosening action is exhibited.

The lead angle acute section can be set in a steeper gradient than a self-lock angle. The self-lock is disclosed, for example, in Japanese Utility Model Registration No. 2577786, which relates to an automobile power seat for feeding a nut member by turning the screw by a motor provided with a worm reduction gear. Locking while not driving the motor is assured by the self-lock of the feed screw or the self-lock of the worm reduction gear.

Thus, while assuring the screw anti-loosening action in the lead angle obtuse section, a large average effective lead is obtained. Therefore, the screw can be tightened or the engaging nut can be advanced by a small rotation.

A method of manufacturing the multipitch screw in the second embodiment is explained with reference to FIG. 14 to FIG. 16.

FIG. 14 (A) is a perspective view of the flat die 4 for manufacturing a multipitch screw, and FIG. 14 (B) is a perspective view of the flat die 5 for manufacturing a constant pitch screw. A pair of the flats die 4 is a substantially rectangular thick plate, and screw threads 40 of nearly opposite shape of the screw threads 20 are formed on the opposite processing side 4a shown in FIG. 13 linearly at a specific inclination to the side of a rectangle. The flat die 4 is for forming a multipitch screw, and the flat die 5 is for forming a conventional constant pitch screw.

As shown in FIG. 14 (A), the a screw thread 40 of the flat die 4 for the multipitch screw is divided into the first range 410, the second range 420, and the third range 430 from the front side of the moving direction (the relatively moving direction of the pair of flat dies, or the direction of arrow A in FIG. 14). The first range 410 occupies about half of the length direction of the flat die 4, and the second range 420 and the third range 430 occupy about one fourth each in the length direction of the flat die 4, and the third range 430 is set to be equivalent to the circumference of the bolt 1 to be rolled and processed.

In the first range 410 and the third range 430 of the flat die 4, linear ordinary screw threads 40a are formed continuously same as in the first embodiment as shown in FIG. 15 (A) and FIG. 15 (B). In the second range 420, multipitch screw threads 40b′ are formed continuously in a shape corresponding to the screw threads 20 excepting the lowest position 21b shown in FIG. 13. FIG. 15 (C) is a partially magnified view of the multipitch screw thread 40b′, and FIG. 15 (D) is a sectional view, and for the ease of understanding, the screw thread 40a is virtually overlaid.

FIG. 16 (A) is an exaggerated and magnified sectional view with the central lines overlaid to explain the difference in basic shape between the constant pitch screw threads 40a and screw threads 40b′ of lead angle varying regularly in stair steps.

The height h1 of constant pitch screw threads 40a is slightly taller than the height h2 of screw threads 40b′ of lead angle varying regularly in stair steps, and the width W1 of constant pitch screw threads 40a at an arbitrary position is set slightly narrower than the width W2 at the corresponding position of screw threads 40b′ of lead angle varying regularly in stair steps.

The difference between height h1 and h2 and width W1 and W2 of constant pitch screw threads 40a and screw threads 40b′ of lead angle varying regularly in stair steps is set to be nearly same in the sectional area of the two.

FIGS. 16 (B1), (B2), (B3), and (B4) are overlaid views of constant pitch screw threads 40a and screw threads 40b′ of lead angle varying regularly in stair steps to explain the difference in basic shape between of constant pitch screw threads 40a and screw threads 40b′ of lead angle varying regularly in stair steps. FIG. 16 (B1) corresponds to section B1-B1 in FIG. 15 (C), FIG. 16 (B2) to section B2-B2 in FIG. 15 (C), FIG. 16 (B3) to section B3-B3 in FIG. 15 (C), and FIG. 16 (B4) to section B4-B4 in FIG. 15 (C).

From the state of the central line 1 of constant pitch screw threads 40a coinciding with the central line 1′ of screw threads 40b′ of lead angle varying regularly in stair steps, the central line 1′ of screw threads 40b′ of lead angle varying regularly in stair steps is changed in the right direction in the diagram to be set in the state in FIG. 16 (B2), and then the central line 1′ of screw threads 40b′ of lead angle varying regularly in stair steps is changed in the left direction in the diagram to be set in the state of FIG. 16 (B3) (same as FIG. 16 (A)), and further the central line 1′ is moved in the right direction in the diagram to be set in the state of FIG. 16 (B4). In other words, the central position of constant pitch screw threads 40a is not moved, but the central position of screw threads 40b′ of lead angle varying regularly in stair steps is moved to right and left of the axial line of screw threads. By settling the constant pitch screw threads 40a in the variation width of screw threads 40b′ of lead angle varying regularly in stair steps, the track rolled by the screw threads 40b′ of lead angle varying regularly is not copied by the constant pitch screw threads 40a as described below.

Linear ordinary screw threads 50a are formed continuously in the entire flat die 5 for a constant pitch shown in FIG. 14 (B). Ordinary screw threads 50a are same in shape as the ordinary screw threads 40a explained in FIG. 15 (A) and FIG. 15 (B).

With reference to FIG. 5, a method of rolling the multipitch screw portion 2 in the bolt 1 by using the flat dies 4, 5 is explained. The pair of flat dies 4, 5 are installed in a known rolling machine. The both flat dies 4, 5 have their processing sides 4a, 5a disposed opposite to each other at a specific interval according to the size of the bolt 1 to be rolled, and are moved in the direction indicated by arrows A and B.

In this state, when the flat dies 4, 5 are moved in the opposite directions indicated by arrows A and B, the shaft of the bolt 1 rotates relatively, and rotates and moves along the first range 410, the second range 420, and the third range 430 of the flat die 4. First, in the shaft of the bolt 1, substantially V-shaped screw grooves reaching the lowest position 21b are formed in the first range 410 of the flat die 4, and in the ordinary screw threads 50a of the flat die 5. In the second range 420 of the flat die 4, the cross hatching area in FIG. 13 (B2) is processed plastically, and a shape as shown in FIG. 13 (B1) is formed. At this time, the shape excluding the lowest position 21b is rolled and processed. The third range 430 of the flat die 4 and ordinary screw threads 50a of the flat die 5 work to shape the bolt 1 and send it out in a profile copying the V-shaped screw grooves 210 formed in the first range 410.

In other words, by the first range 410, the second range 420 and the third range 430 of the flat die 4 and the ordinary screw threads 50a of the flat die 5, screw grooves shown in FIG. 13 are formed in the shaft (multipitch screw portion) of the bolt 1, and thereby comparative multipitch screw threads 20 are formed.

In the second embodiment, same as in the first embodiment, after forming tracks (lowest position 21b) of equal lead angle screw threads on the outer circumference of the shaft-like blank piece by the first range 410 of the flat die 4, by the second range 420, stair step screw tracks (stair step left and right flank surfaces 201L, 201R, 202L, 202R) are formed, and therefore multipitch screw thread tracks varying in the applied force at the time of rolling can be formed easily.

In this processing, as mentioned above, since the sectional area of constant pitch screw threads 40a and screw threads 40b′ of lead angle varying regularly in stair steps is set to be nearly identical, and at the changeover point from the first range 410 to the second range 420 of the flat die 4, the plastic deforming amount of the outer circumference of the multipitch screw portion 2 of the bolt 1, that is, the load of work is nearly uniform. Hence, biased load is not applied to the flat die 4 when rolling multipitch screw threads 20 in the outer circumference of the multipitch screw portion 2 of the bolt 1.

### INDUSTRIAL APPLICABILITY

In the foregoing explanation, the rolling process using flat dies 4, 5 is explained, but the invention may also be applied in rolling process using rotary dies.

### BRIEF DESCRIPTION OF THE DRAWINGS

FIG. 1 is a side view of a bolt having a multipitch screw portion in a first embodiment.

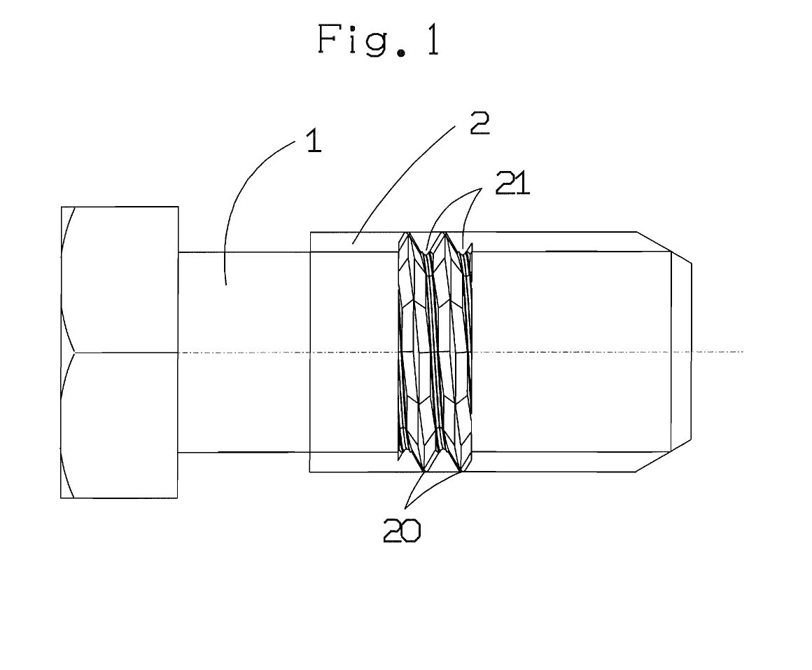

FIG. 2 is a partially magnified view of the multipitch screw portion 2.

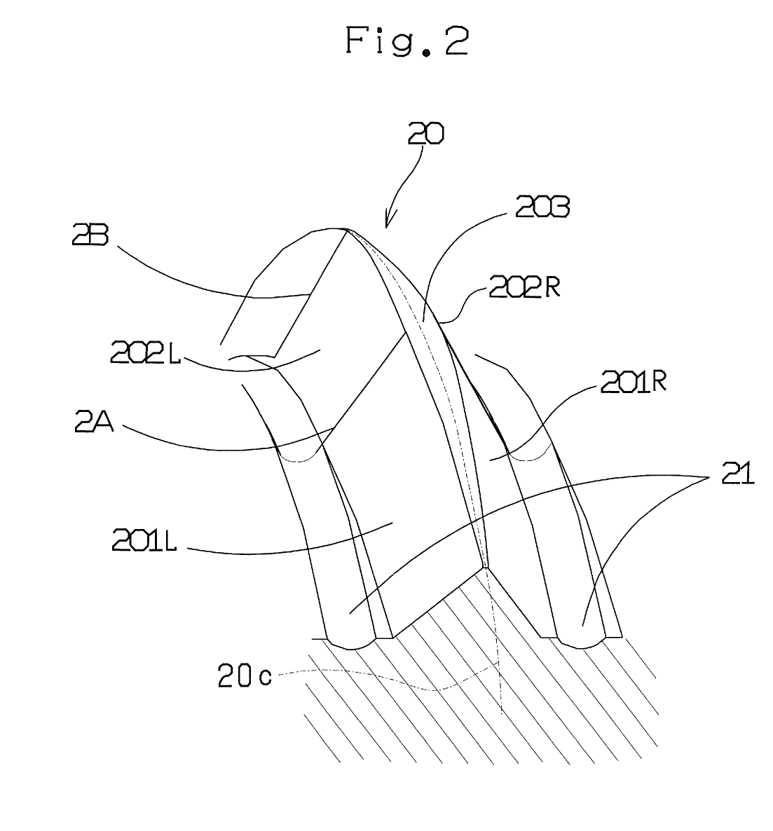

FIG. 3 is a linearly developed view of the multipitch screw portion 2.

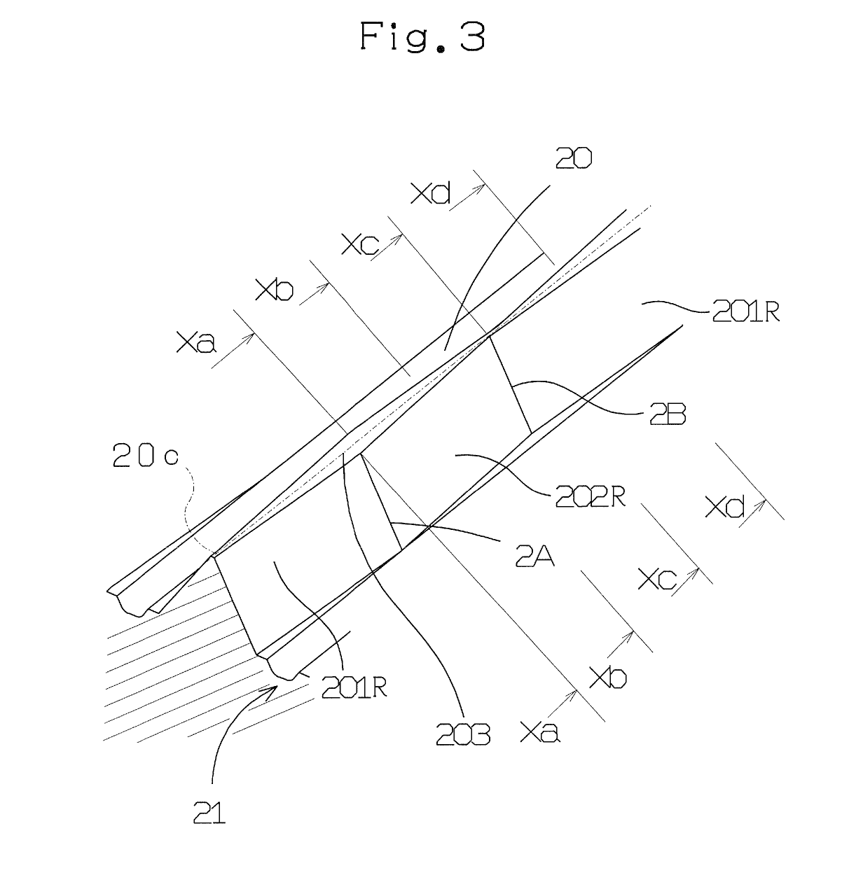

FIG. 4 is a sectional view showing Xa to Xd parts in FIG. 3.

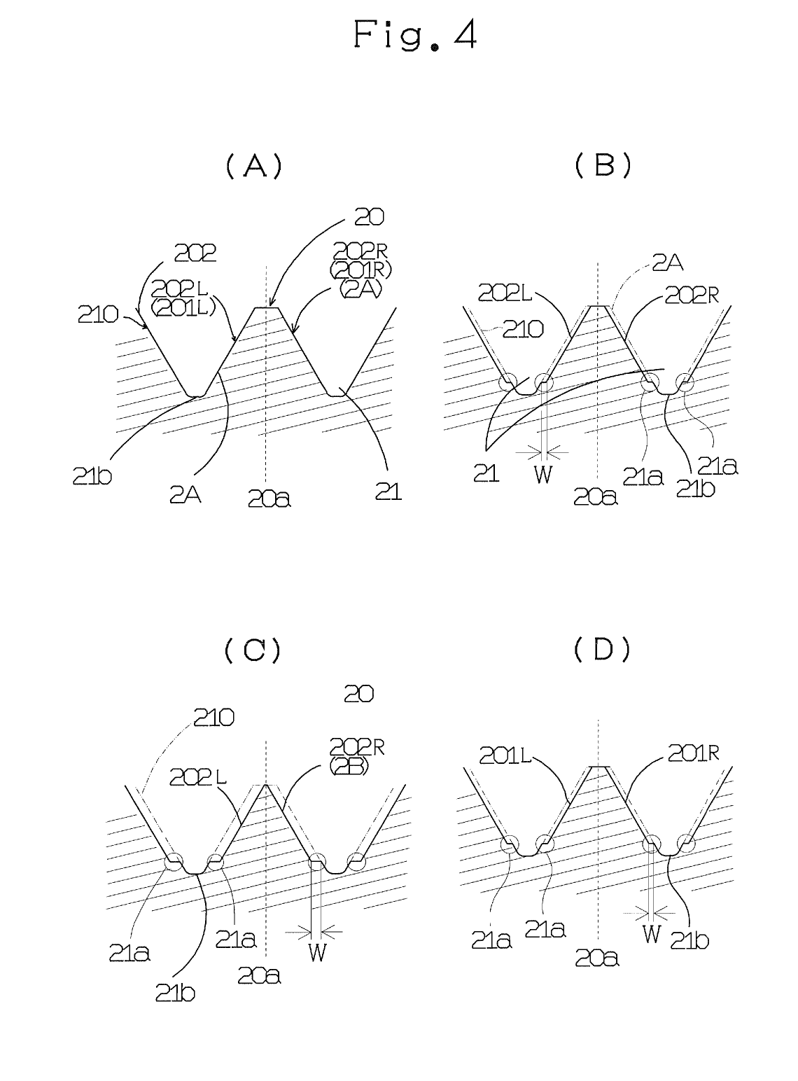

FIG. 5 is an explanatory diagram showing a method of manufacturing the screw portion 2 by using a pair of flat dies 4, 5.

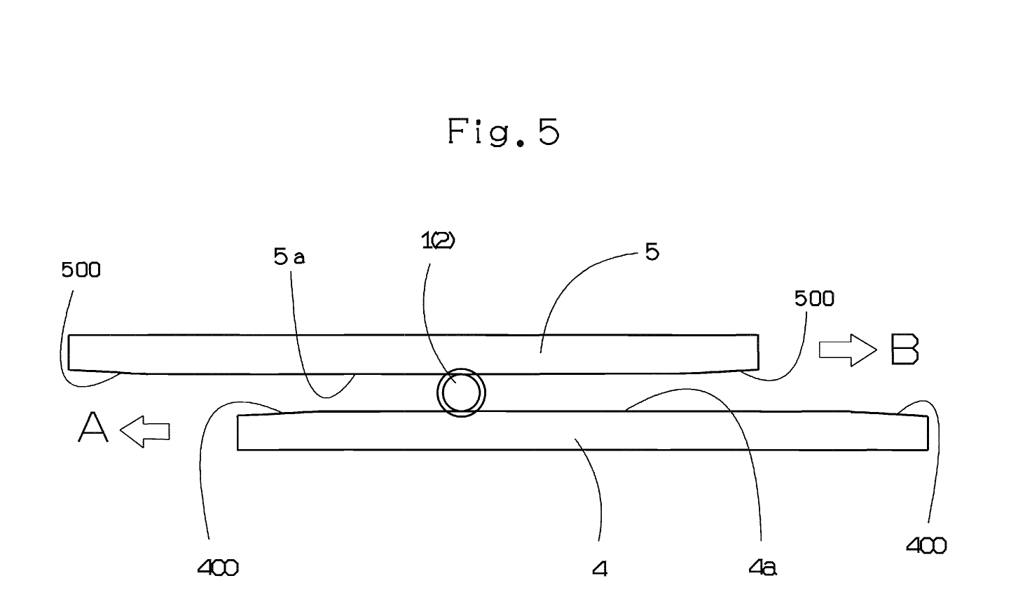

FIG. 6 (A) is a perspective view of a flat die 4 for manufacturing the multipitch screw in the first embodiment, and FIG. 6 (B) is a perspective view of a flat die 5 for manufacturing a constant pitch screw.

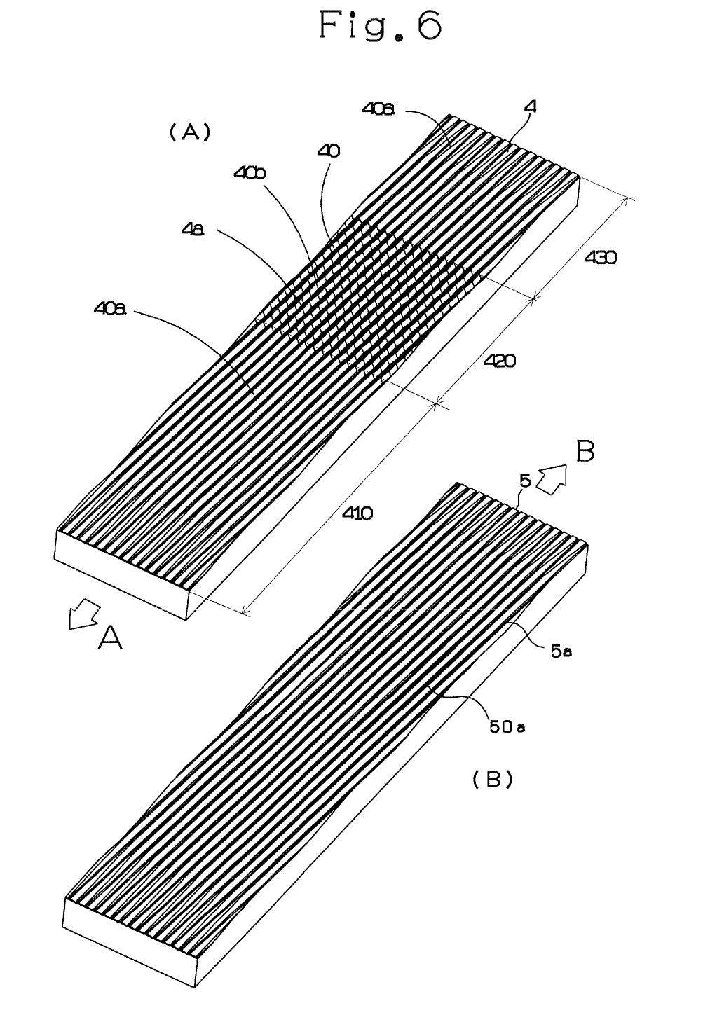

FIG. 7 is a partially magnified view and a sectional view of ordinary screw threads 40a and multipitch screw threads 40b.

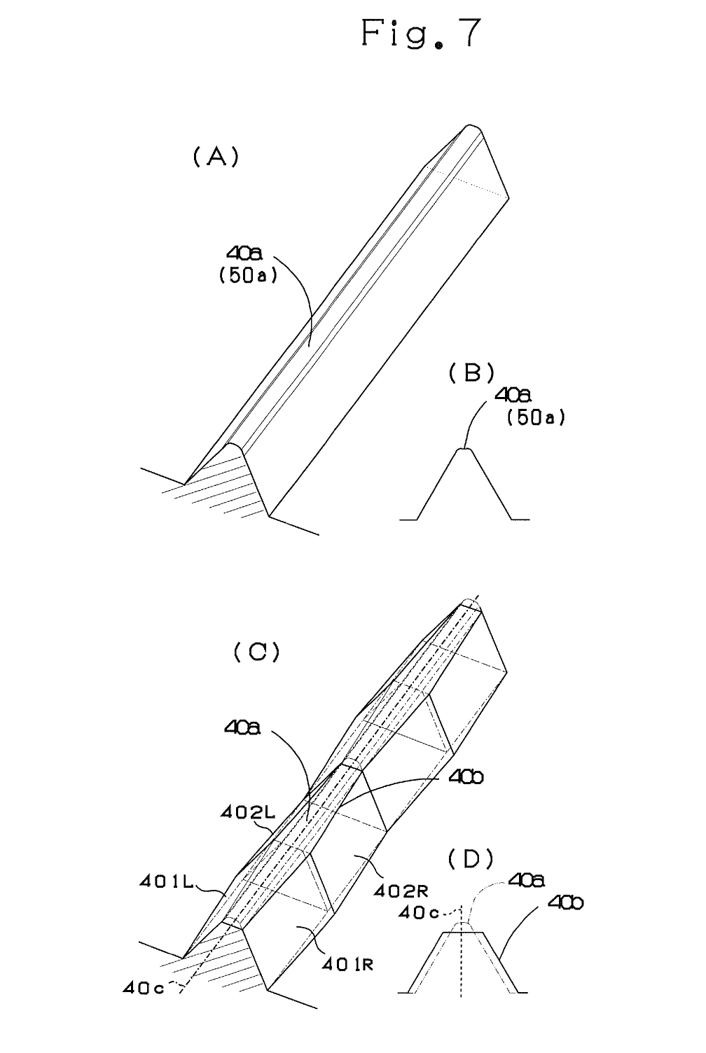

FIG. 8 is a partially magnified sectional view of substantially V-groove screw grooves 210 formed in a first range 410 of flat dies 4, 5.

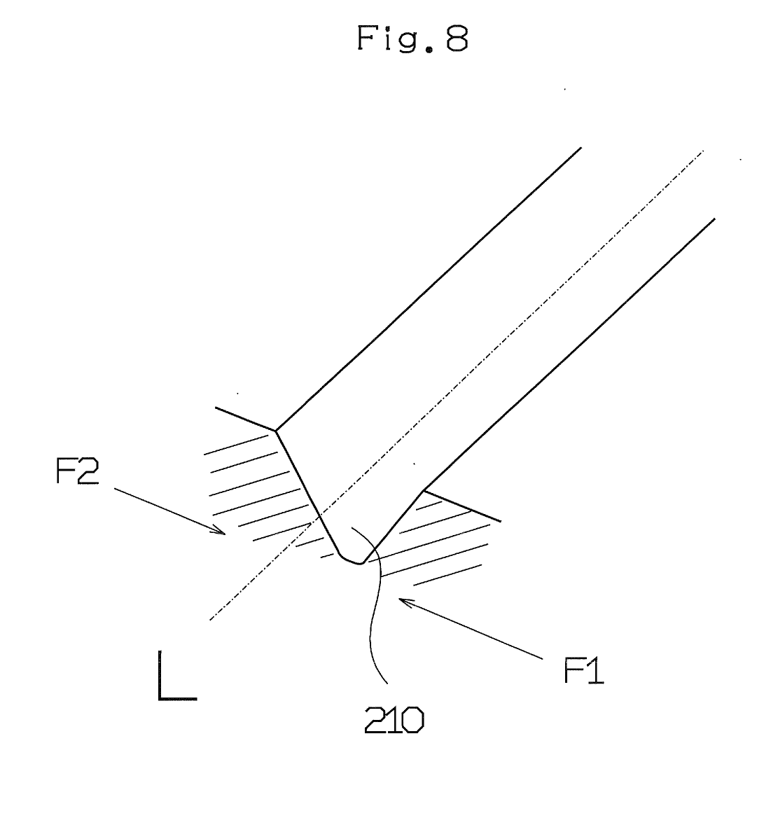

FIG. 9 is a partially magnified sectional view of substantially V-groove screw grooves 210 formed in a second range 420 of flat dies 4, 5.

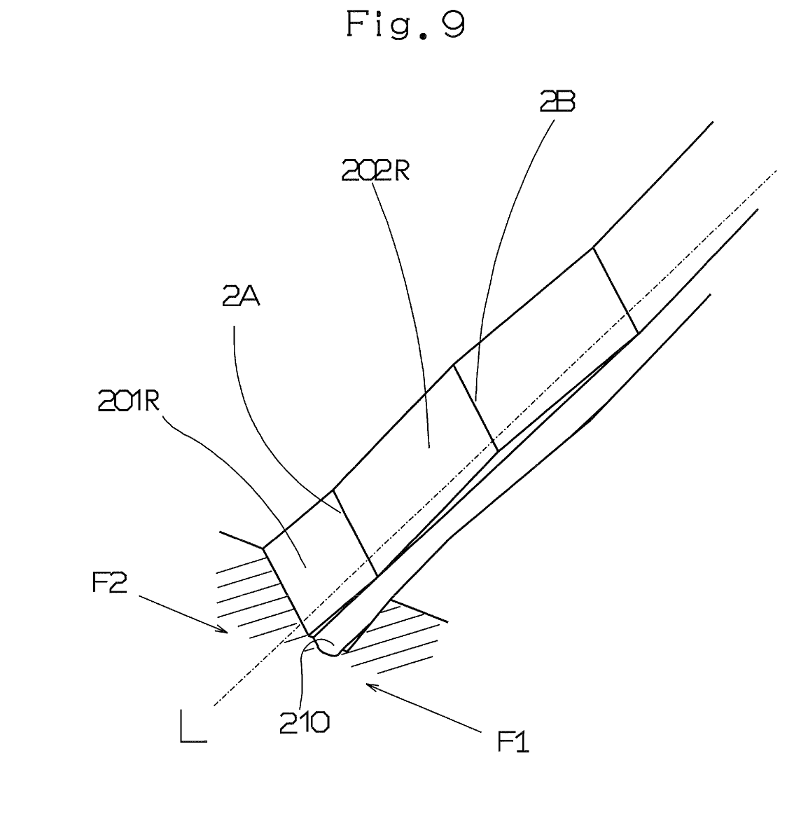

FIG. 10 is a linearly developed view of the multipitch screw portion in a modified example of the first embodiment using trapezoidal screw threads.

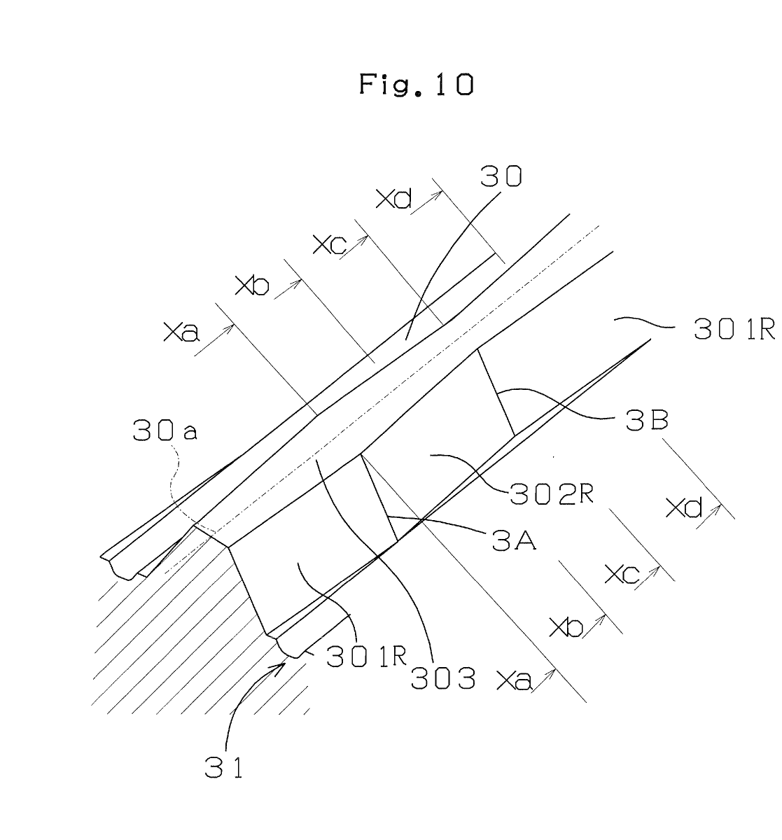

FIG. 11 is a sectional view showing Xa to Xd parts in FIG. 10.

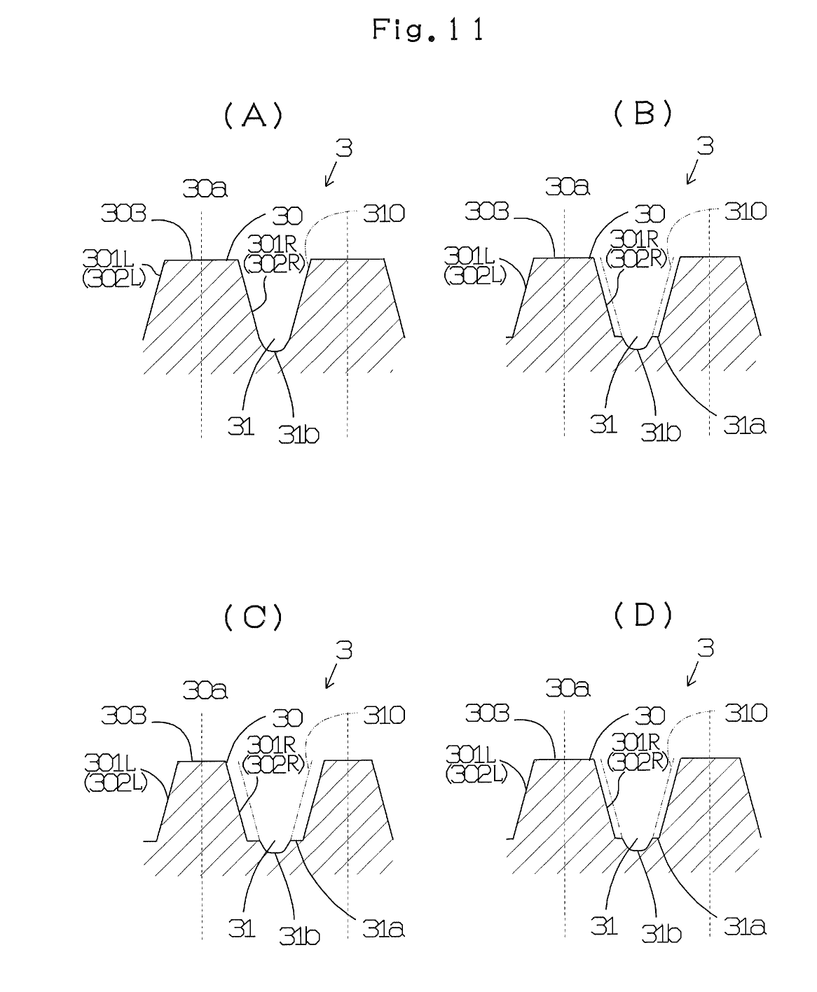

FIG. 12 is a side view of a bolt having the multipitch screw portion in a second embodiment.

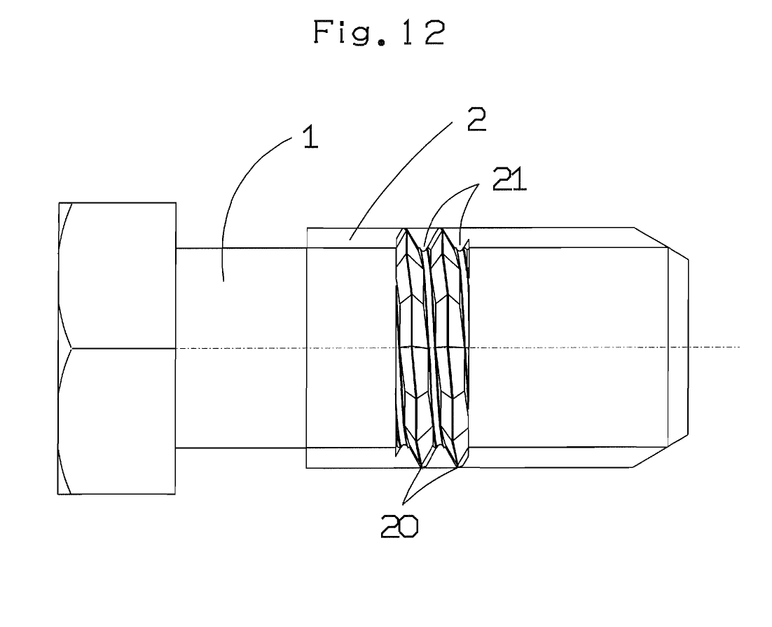

FIG. 13 is a linearly developed view of the multipitch screw portion 2 in the second embodiment.

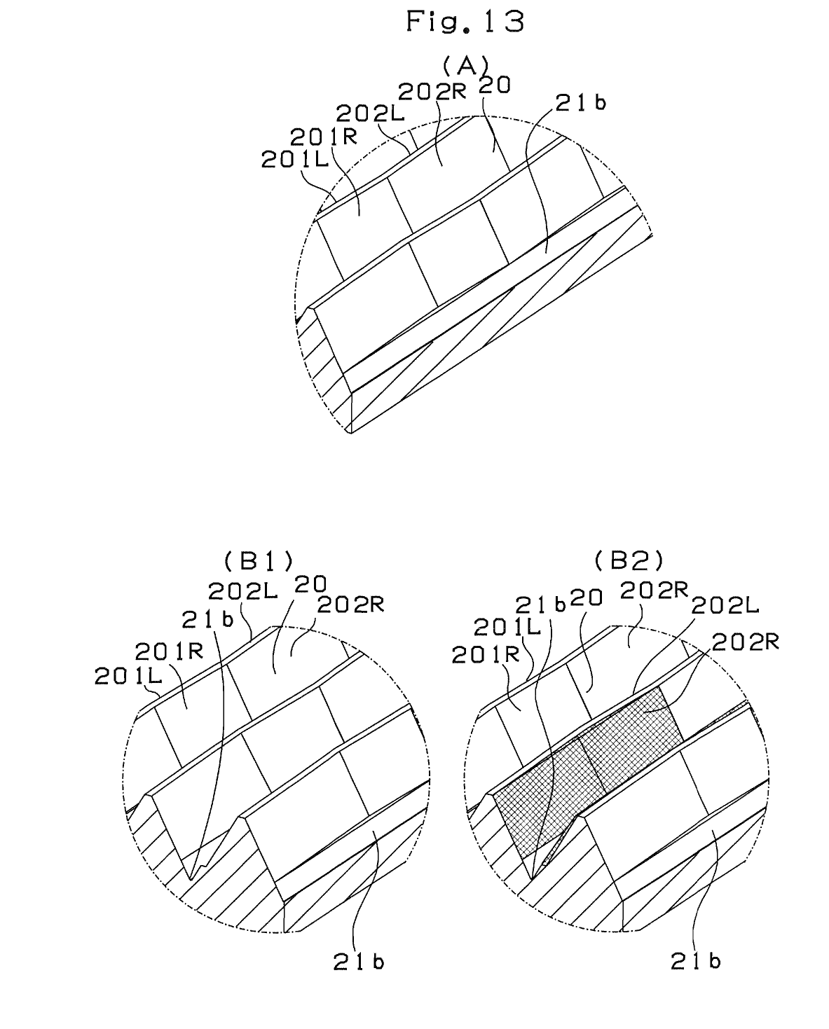

FIG. 14 is a perspective view of flat die 4 and flat die 5 in the second embodiment, more specifically FIG. 14 (A) is a perspective view of the flat die 4 for manufacturing the multipitch screw in the second embodiment, and FIG. 14 (B) is a perspective view of the flat die 5 for manufacturing the constant pitch screw.

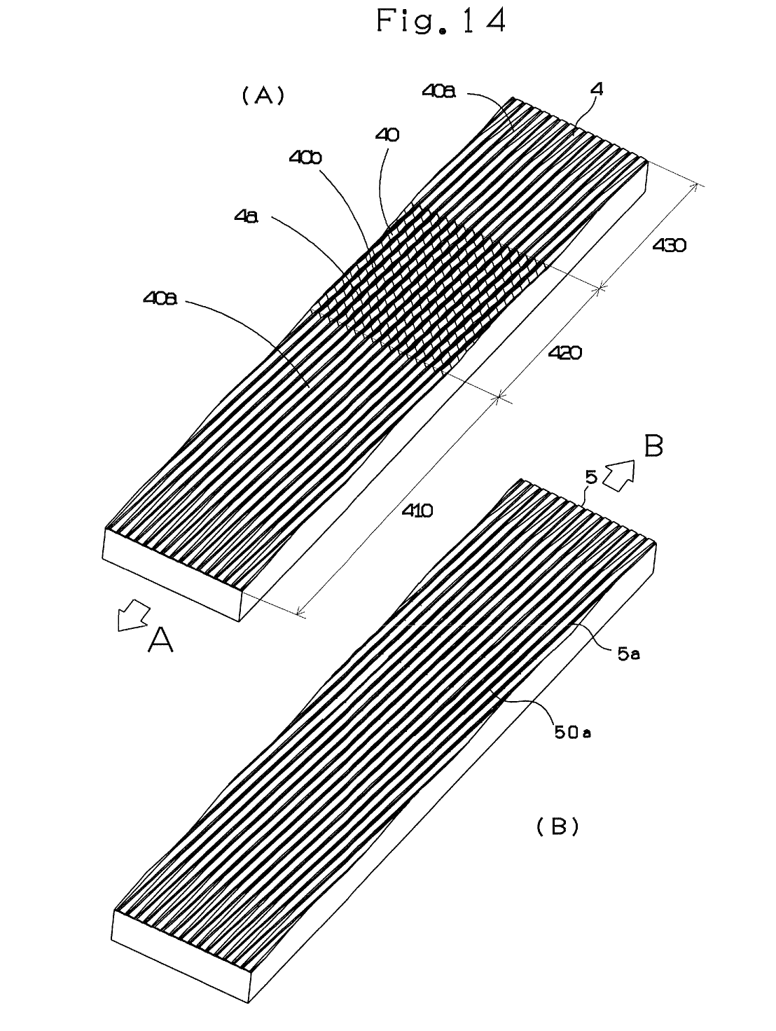

FIG. 15 is a partially magnified view and a sectional view of ordinary screw threads 40a and multipitch screw threads 40b′.

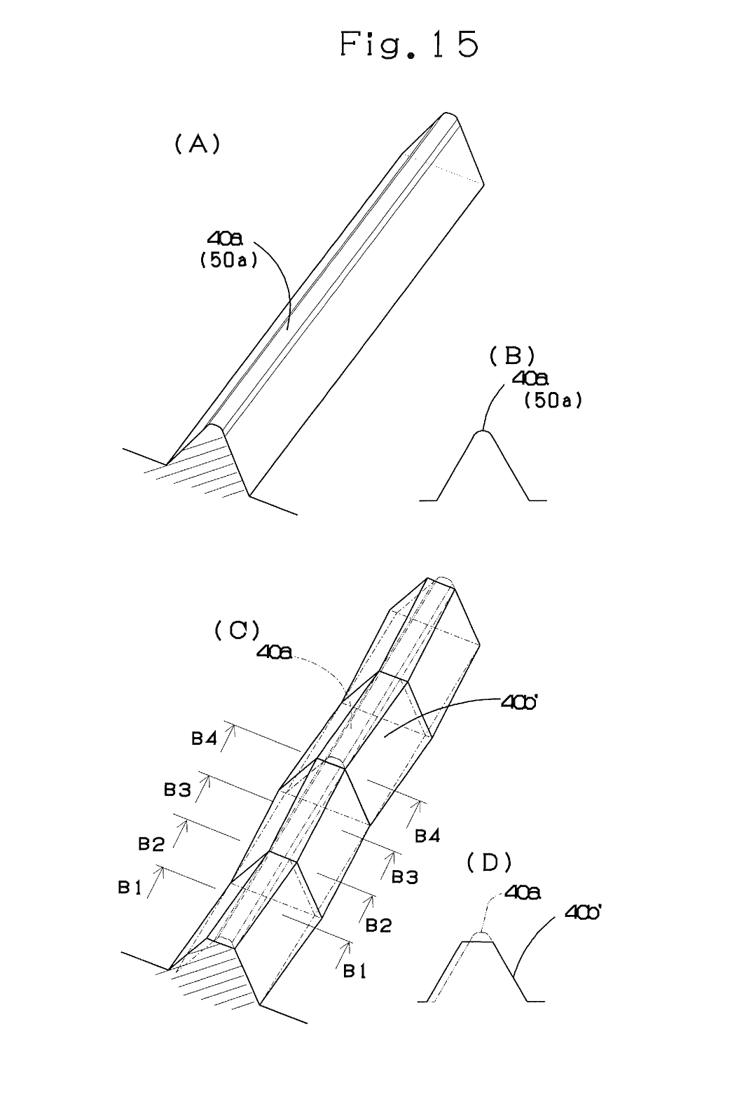

FIG. 16 is a sectional view showing B1 to B4 parts in FIG. 15.

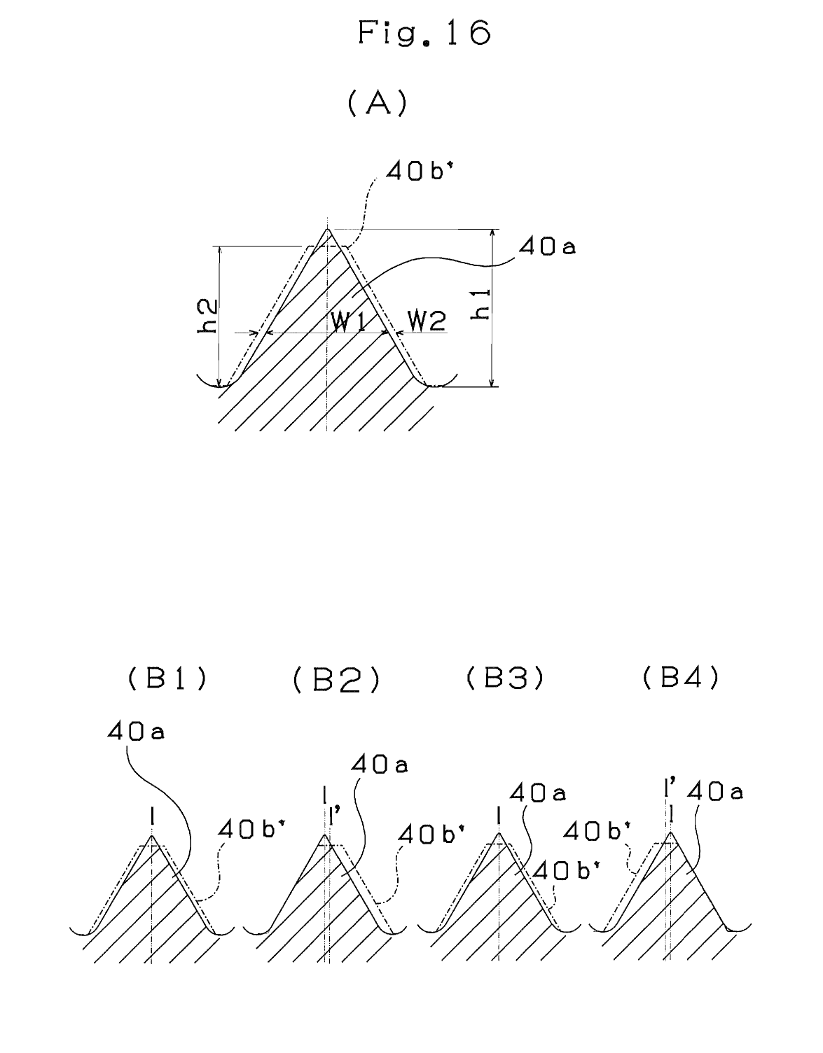

1. A multipitch screw characterized by having side walls of screw threads, formed alternately and consecutively, alternating between a lead angle obtuse section and a lead angle acute section while rotating along a helix, and symmetrically to a central line of screw threads.

2. The multipitch screw of claim 1, wherein the bottom between a screw thread and a screw thread is a screw groove shape of a constant lead angle.

3. A manufacturing method of a multipitch screw comprising the steps of rolling and processing spiral multipitch screw threads on an outer circumference of a shaft-like blank piece, by a pair of flat dies having a plurality of substantially inverted-V protrusions on the surface,
wherein at least one flat die has protrusions for screw threads of lead angles regularly varying alternately and consecutively having both side walls alternating between a section departing from a central line and an approaching section along the central line, and symmetrically to the central line, and
multipitch screw threads are rolled on the outer circumference of the shaft-like blank piece, alternately and consecutively, alternating between lead angle obtuse sections and acute sections, by protrusions for screw threads regularly varying in the lead angle of one flat die.

4. A manufacturing method of a multipitch screw comprising the steps of rolling and processing spiral multipitch screw threads on an outer circumference of a shaft-like blank piece, by a pair of flat dies having a plurality of substantially inverted-V protrusions on the surface,
wherein at least one flat die has a region for screw threads of a constant lead angle in protrusions, and a region for screw threads of a lead angle varying regularly, to be consecutive to the region, slightly lower in height than this region for screw threads of the constant lead angle, and alternately and consecutively, alternating in both side walls between a section departing from the central line of protrusions and an approaching section along the central line, symmetrical to a central line and
multipitch screw threads are rolled on the outer circumference of the shaft-like blank piece, overlaid between tracks of a constant lead angle screw formed by the protrusions of the region for constant lead angle screw threads of one flat die, and screw tracks alternately and consecutively, alternating between the lead angle obtuse section and the acute section formed by protrusions of the region for screw threads of a lead angle varying regularly.

5. A manufacturing method of a multipitch screw comprising the steps of rolling and processing spiral multipitch screw threads on an outer circumference of a shaft-like blank piece, by a pair of flat dies having a plurality of substantially inverted-V protrusions on the surface,
wherein at least one flat die has a region for screw threads of a constant lead angle in protrusions, and a region for screw threads of a lead angle varying regularly in stair steps, consecutive to the region, slightly wider in width of a sectional shape than this region for screw threads of the constant lead angle, slightly lower in height, and changing like waves in a groove direction, and
multipitch screw threads are rolled on the outer circumference of the shaft-like blank piece, overlaid between tracks of constant lead angle screw threads formed by the protrusions of the region for constant lead angle screw threads of one flat die, and screw tracks in stair steps, formed by protrusions of region for screw threads of lead angle varying periodically.

6. The manufacturing method of a multipitch screw of any one of claims 3 to 5, wherein the pair of flat dies include a flat die having protrusions composed of a region for constant lead angle screw threads and a region for screw threads of lead angle varying regularly, and a flat die having protrusions composed only of screw threads for a constant lead angle.

7. A manufacturing apparatus of a multipitch screw used in the manufacturing method of multipitch screw of any one of claims 3 to 6.
